(19) United States
(12) Patent Application Publication
(10) Pub. No.: US 2001/0011295 A1
(43) Pub. Date: Aug. 2, 2001

(54) Method for cooperating multiple application programs

(76) Inventors: Takashi Kobayashi, Kawasaki (JP); Masato Tamaki, Zushi (JP); Makoto Ogawa, Yokohama (JP); Kazuyuki Aoyama, Kawasaki (JP); Takashi Kashimoto, Yokohama (JP); Atsushi Kobayashi, Kawasaki (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/773,568

(22) Filed: Feb. 2, 2001

(30) Foreign Application Priority Data
Feb. 2, 2000 (JP) 2000-030214

(51) Int. Cl. G06F 15/16

(52) U.S. Cl. 709/201

(57) ABSTRACT

The procedures for executing a plurality of applications to be integrated are defined on templates. Then, the applications to be integrated are executed by integration workflow means in accordance with the procedures defined on the templates. Thus, even though a plurality of applications provided within an enterprise are integrated and managed to produce a new added value by using a killer application, the number of processes and period of time necessary for development can be reduced.

### BACKGROUND OF THE INVENTION

The present invention relates to a method for cooperating multiple application programs in a computer system that corporations or public offices use for executing their jobs.

Organizations such as firms or public institution have made much investment for rationalization in the basic affairs such as accounting, human resources management, product management or sale management, and in most cases computer systems have been used for that purpose. Computer programs, business processes, data base, files and so on developed for performance of jobs are called application. When products and services were not changed under stable business environment in the past, it was only necessary that each operation division perform the assigned primary responsibility. Therefore, an application was developed for each operation division, and it was not necessary for different applications to share information. However, when needs in market rapidly change as in the present time, each business is demanded to flexibly act in concert with other peripheral businesses and to produce a new merchandise or service from which customers can get great satisfaction.

For the above reasons, project management program packages called killer applications have been developed to integrate and manage multiple applications in firms, thus producing new added values. The killer applications are usually needed to fast process a large amount of data the existing applications have, and to make the results be shared by a wide range of applications. Thus, most of killer applications use the up-to-date information technology such as high-performance devices, large-capacity memories/desks, fast algorithm and Internet. For example, there are a material resource computing program for manufacturing fields, and a sale data multidimensional analysis program for distribution fields.

The operations for using a killer application in a business system usually include the following two steps.

At step 1 (business design), a new procedure for business is designed that is based on the killer application and that has common business processes and information to optimize the whole system.

At step 2 (system design/implementation), system design and software development are performed for sharing business processes and information between a killer application and existing applications.

Since a killer application is used not only in a closed work of an individual affair but in a wide field of all business processes as described above, the number of operations becomes tremendous in most cases. Thus, the way that the number of operations can be reduced has been considered so far.

The problems in the system design and implementation have early been analyzed, and a reform measure has been considered. The problems with the sharing of information between the killer application and existing applications are as follows. Since various different applications have been developed individually in accordance with the respective businesses, they have no contrivance to receive or deliver information from/to other ones. Therefore, in order to use a killer application, it is necessary to develop a new program for processing the interface to other peripheral systems. Since the working environment, programming language and operation method of each application are usually different from those of other ones, an interface process program is necessary for the related applications. Thus, a large number of processes are necessary for the development and maintenance. As a countermeasure for solving this problem, an enterprise application integration (EAI) has recently been highlighted which can connect applications and make data be shared by the applications. The EIA normally uses middleware called message broker to connect applications. The message broker mediates information between a plurality of applications in a form of message. The message broker has generally the following functions.

Message interpretation: it converts forms of message expression in accordance with applications.

Intellective routing: it discriminates a message and delivers it to an appropriate application.

Rule engine: it interprets a message and processes a routing rule.

By use of the above functions, it was possible to greatly reduce the number of operations for the development of the interface process program.

### SUMMARY OF THE INVENTION

The EAI technology has solved the problems associated with the system design and implementation at the time of using the killer application as described above. However, a problem with the business design of “design of a new procedure for optimizing the whole system” has come under close scrutiny. The counter-measure for reducing the number of processes in the business design has so far been proposed in a form of task template by killer application vendor, SI vendor and consulting firm. The term, task template, shows the business process model and data model recommended for making killer application effect operative, and it is also called reference model. By reference to the task template, it is possible to make business design with less number of processes than with zero base. In practice, however, object of business and restriction conditions for each user are different from those for other ones, and thus an approach is taken for finding points of compromise between the task template and the actual task. In other words, the actual task is changed in accordance with the task template, or the task template is customized in conformity with the actual task. The operation for this adjustment needs the knowledge-intensive study by the following human resources.

Job expert: an expert familiar with actual task and having the authority to change the task style according to need. The job expert is generally assigned to each business.

Responsible person of project: a person in charge having the final decision power for changing the actual task or customizing the task template.

Consultant: a person familiar with the killer application and task template and having the ability to evaluate the cost and effect by customizing.

These excellent human resources are generally hard to find, and even if found, they are often very busy. Therefore, this adjustment operation was a bottleneck in use of killer application.

Accordingly, it is an object of the invention to solve these problems and make business design with a small number of processes and in a short time at the time of using a killer application.

It takes a long time to adjust the task template and actual task because the task template specifies up to high-severalty details. The result is that when a system is constructed on the basis of the task template, the procedure for task operation needs to be totally changed. In addition, corporate ladder, office regulation and contract with customer might be changed.

Thus, the task template according to the invention does not define the individual procedures within each one of business to be combined, but lays down only the procedure for the operations between the businesses. The killer application was originally not developed for particular users, but made for assumed domains in a multipurpose way. Therefore, a macro-procedure between business to be integrated is defined according to the business process model and data model based on the killer application. However, since this task template has no high-severalty details provided, it is difficult to perform actual task with only that template. Thus, the current business process and existing applications are incorporated without change in the details of each affair. For this purpose, the following system cooperation functions are provided.

Integration workflow: it manages the progress according to the business process model regulated in the task template, recognizes a business to be executed, and orders to do.

Task start command: it is ordered by the integration workflow to transmit an execution start signal to the application group and human for executing the corresponding task.

Task completion detection: it detects a signal indicating that the application group and human have finished the task.

Data transformer: it obtains information indicative of the task execution result and delivers it to the killer application. If necessary, information structure, type and value are converted.

Plan information notification: it informs the application group and human of the processed result from the killer application. If necessary, information structure, type and value are converted.

Under the macro-level task template and system cooperation function mentioned above, the killer application can be applied, taking a small number of processes and a short period of time, without changing the current task style and customizing the task template.

However, as might be expected, the current task portion incorporated in an individual business cannot be assured of its adaptation to the new task style after the application of killer application. However, as compared with the aiming at the whole optimization that takes a large number of processes and a long time, use of killer application that takes a small number of processes and short period of time will reduce the risk and give a large effect in business even though there is some defect. The improvement in each business should be made step by step while the killer application is being applied.

The contents of templates, specification of the cooperation function and method of making use of the killer application, according to the invention, will be described in detail under the consideration of the above discussion.

### (1) Contents of Templates

The business process model and data model necessary to execute the plan management process by killer application are specified as follows.

Business process model: it shows the task group and their execution procedure necessary for the killer application to perform the plan management process. The killer application usually specifies only the input/output information group necessary for the plan management process. Therefore, the business model covers the task group that generates or uses those information. This business process model defines the business process for executing the task execution management (workflow management) as a cooperation function as given below.

Data model: it shows the entity group of input/output information from/to the killer application, and their association, structure and type. This data model defines the input/output file from/to the killer application. In addition, it is used for defining the information conversion rule in the data transformer and plan result notification as cooperation functions described below.

### (2) Specification of Cooperation Function

The templates are provided with the following cooperation functions in order to connect the existing applications and business processes without change.

Integration workflow: it performs the so-called workflow management, that is, manages the progress in accordance with the business model specified in the task template, recognizes a task to be performed, and orders to do.

Task start command: it is ordered by the integration workflow to transmit an execution start signal to the application group and human for performing the corresponding task. For example, it transmits a start command to computer programs or business processes or it transmits a start notification mail to the human.

Task completion detection: it detects a signal indicating that the application group or human has completed the task. For example, it receives a computer program end command or business process end command, monitors the change of value in information storage mean such as database or file and accepts a mail from the human.

Data transformer: it acquires information indicative of task executed result and delivers it to the killer application. The process execution timing is decided from the task completion detection. If necessary, information structure, type and value are converted. The information conversion rule is defined by the relationship between the data model of input information to the killer application and the data model of the task execution result information.

Plan information notification: it informs the application group or human of the processed result from the killer application. If necessary, information structure, type and value are converted. This information conversion rule is defined by the relationship between the data model of output information from the killer application and the data model of the task plan information.

### (3) Method of Applying Killer Application

The killer application is applied to the business system on the basis of the task template and cooperation functions and according to the following procedure.

Step 1 (Task Design)

Requirement analysis: functions are determined to actualize a new business. In this case, a killer application to be used is selected, and it is considered to make best use of that function.

Business process design: a killer application or application group in an actual business is assigned to each step of the business process model of the task template, and it is confirmed that a new business can be materialized.

Data model design: information storage means such as files, database and message in an actual affair is assigned to each entity of the data model of the task template, and it is confirmed that necessary information exists.

If there is no application group required by the task template, a new application group is designed, if necessary.

Step 2 (System Design)

Input/output design: an input/output flow is designed to be inserted between the killer application and the application group in an actual business.

Cooperation system design: the specification of the cooperation function is determined to start the application group and detect the end thereof according to the business process model of the task template.

Data conversion system design: the specification of the conversion is designed to be inserted between the input/output file of the killer application (described as the data model of the task template) and the information storage means in the actual business.

Step 3 (Implementation)

Cooperation component development: a program is developed according to the specification of the above cooperation functions.

System implementation: the business process model of the task template is implemented by a workflow tool, and the data model is implemented by a database tool. In addition, the killer application and the application group in an actual business are forced to cooperate with each other by use of cooperation parts.

Step 4 (Enhancement)

Step-by-step enhancement: the actual business portion forced to cooperate with each task step of the business process model is enhanced step by step while the killer application is being applied. This enhancement is performed for use of application package, development of a new user program and introduction of workflow.

### BRIEF DESCRIPTION OF THE DRAWINGS

FIG. 1 shows the whole construction of the cooperation infrastructure for the integration of applications according to the invention.

FIG. 2 shows the business process model of the task template according to the invention.

FIG. 3 shows the data model of the task template according to the invention.

FIG. 4 shows the start completion rule used in the task start command function and task completion detection function according to the invention.

FIG. 5 shows the procedure of the task start command function.

FIG. 6 shows the procedure of the task completion detection function.

FIG. 7 shows the division conversion rule used in the data transformer function and plan information notification function of the invention.

FIG. 8 shows a method of generating the program for the data transformer function.

FIG. 9 shows a method of generating the program for the plan information notification function.

FIG. 10 shows a procedure for making a killer application and an existing/new application group cooperate with each other by use of the cooperation infrastructure for application integration according to the invention.

### DESCRIPTION OF THE EMBODIMENTS

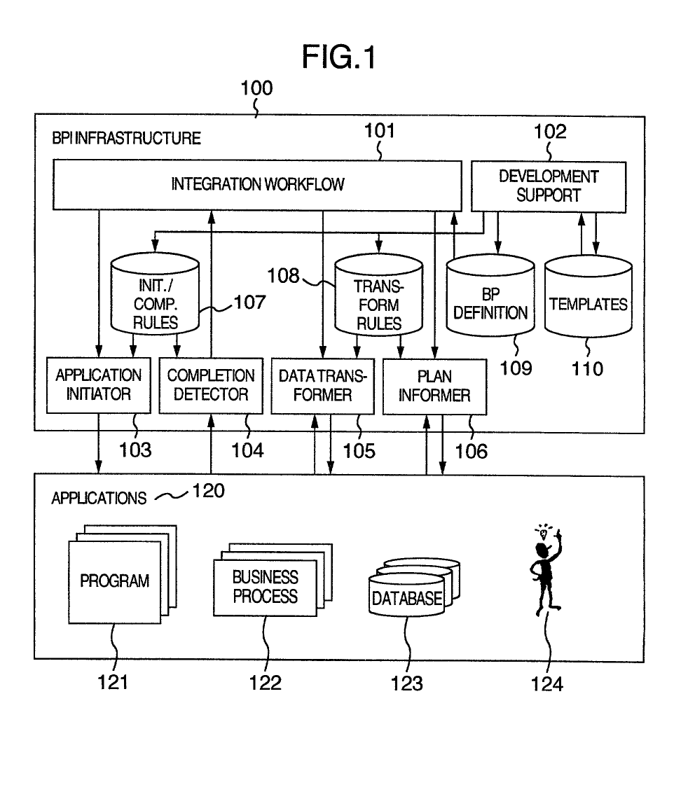

Embodiments of the invention will be described with reference to FIGS. 1 through 10.

FIG. 1 shows the whole construction of an application cooperation infrastructure for the integration of applications, according to the invention. Referring to FIG. 1, there is shown an application infrastructure 100 that includes six functions of an integration workflow 101, a development support 102, an application initiator, or start command 103, a completion detector 104, a data transformer 105, and a plan informer 106. In order to integrate applications by these functions, there are also provided four storage means of initiation/completion rules 107, transform rules 108, business process definition 109, and templates 110. Moreover, there are shown applications 120 at which the infrastructure 100 targets. The applications 120 include a program 121, a business process 122 of workflow, a database 123 and a human 124.

The integration workflow 101 is the so-called workflow management function that manages the progress according to the business process model specified in the templates 110, recognizes tasks to be executed and orders to do. The application initiator 103 is ordered by the integration workflow 101 to transmit an execution start signal to the applications or human by which the corresponding tasks are executed. For example, it transmits a start command to the program 121 and business process 122, and causes a start signal to be written at a predetermined data item of the database 123 or sends a start mail to the human 124. The completion detector 104 detects a signal indicating that the applications or human has completed the tasks. For example, it monitors an end command from the program 121 or business process 122, monitors the change of the value at the predetermined data item in the database 123, and receives a task completion mail from the human 124. The start command and completion detection specifications that change according to the kind of application are defined by the development support 102 and stored in the initiation/completion rules 107 as start completion rule. The data transformer 105 acquires information of task executed results from the program 121 and database 123 of applications 120, and delivers it to a killer application in applications 120. The execution timing is decided by the completion detector 104. The plan informer 106 receives the result of process from the killer application of applications 120 and sends it to the program 121 and database 123 of applications 120. In these data transformer and plan informer, information structure, type and value are converted, if necessary. The conversion specifications are previously defined by the development support 102, and stored in the transform rules 108. The templates 110 show the business process model and data model necessary for the killer application to execute the plan execution process, and can be customized according to actual tasks by use of the development support 102. The business process definition 109 is definition information of workflow tool for the integration workflow 101, and defines on the basis of the business process model in the templates 110 and by use of the development support 102.

A component supply operation in the assembling manufacturing industry will be described as an embodiment of the invention. In this embodiment, a high-speed material resource computing program is employed as a killer application. The use of this program enables the existing production management and component order tasks to share production planning information, component stock information and order information to component makers, and thus the stock and business lead time can be more reduced than in the prior art.

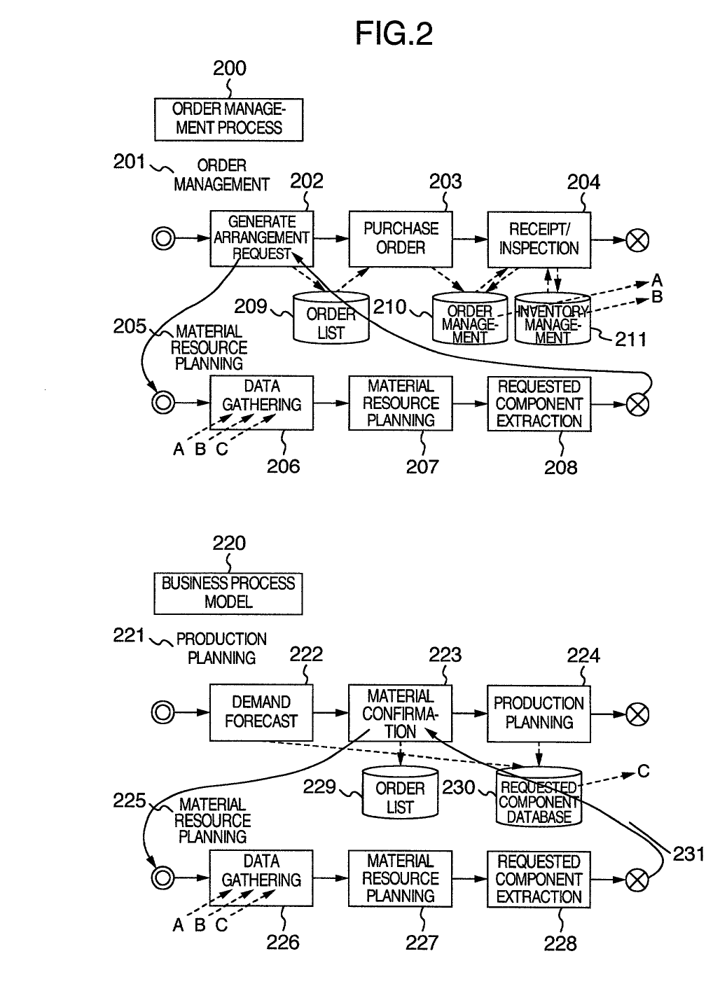

The templates of the invention will be first described. FIG. 2 shows the business process model in the templates. Only the tasks and procedures are shown that are necessary for the killer application to execute plan management. A method of specifying business process model will be described below. The killer application of this embodiment is a high-speed material resource planning program, and is used for order management and production plan. Three pieces of information, or order management, inventory management and production plan are inputted, and an amount of components to be newly ordered is outputted. The order management and inventory management information are generated by purchase order task, and the production plan information is generated by production plan task. These two tasks utilize requested component information as a result of high-speed material resource planning. Therefore, the business process model handles only the order management and production plan, and shows the minimum range of execution order in which information is transmitted and received between these tasks and the high-speed material resource planning program.

FIG. 2 shows the business process model as the result. In FIG. 2, reference numeral 200 represents the business process model of purchase order management, which includes an order management 201 that timely supplies necessary components, and a material resource planning 205 for calculating the amount of arranged components in real time. The order management 201 is formed of three sub-tasks of an arrangement request generator 202, a purchase order 203 and a receipt/inspection 204. The management request generator 202 calculates the amount of arranged components on the basis of day-to-day real time information with the high-speed material resource planning program used, and registers it in an order list database 209. The purchase order 203 informs each customer of order check on the basis of the information in the order list 209, and registers the result in the order management database 210. The receipt/inspection 204 inspects the ordered components arrived from customers, and registers the result in the order management database and inventory management database. The material resource planning 205 is formed of three processors, or data gathering 206, material resource planning 207 and requested component extraction 208. In this material resource planning 207, three pieces of information, or production planning 230, order management 210 and inventory management 211 inputted to the data gathering 206 are processed. In the requested component extraction 208, requested component information 209 is produced after the material resource planning 207.

There is also shown a business process model 220 of production plan. This model is formed of production planning 221 for timely generating a production plan with product demand and supply capacity balanced, and material resource planning 225 for simulating a necessary amount of components in real time on the basis of product demand. The production planning 221 is formed of three sub-tasks, or demand forecast 222, material confirmation 223 and production planning 224. The demand forecast 222 predicts the amount of product demanded on the basis of the past turnover record and market trend, generates a draft for product plan, and then registers it in the production planning database 230. The material confirmation 223 utilizes the high-speed material resource planning program, calculates the amount of requested components on the basis of the draft of production plan, and registers it in the requested component database 229. In this case, the amount of components requested to each customer, and delivery date are adjusted so that the amounts of components to be demanded and supplied can be balanced. The production planning 224 generates the final draft of production planning on the basis of the final requested component information, and registers it in the production planning database 230. The material resource planning 225 is formed of three processors like 205, or data gathering 226, material resource planning 227 and requested component extraction 228.

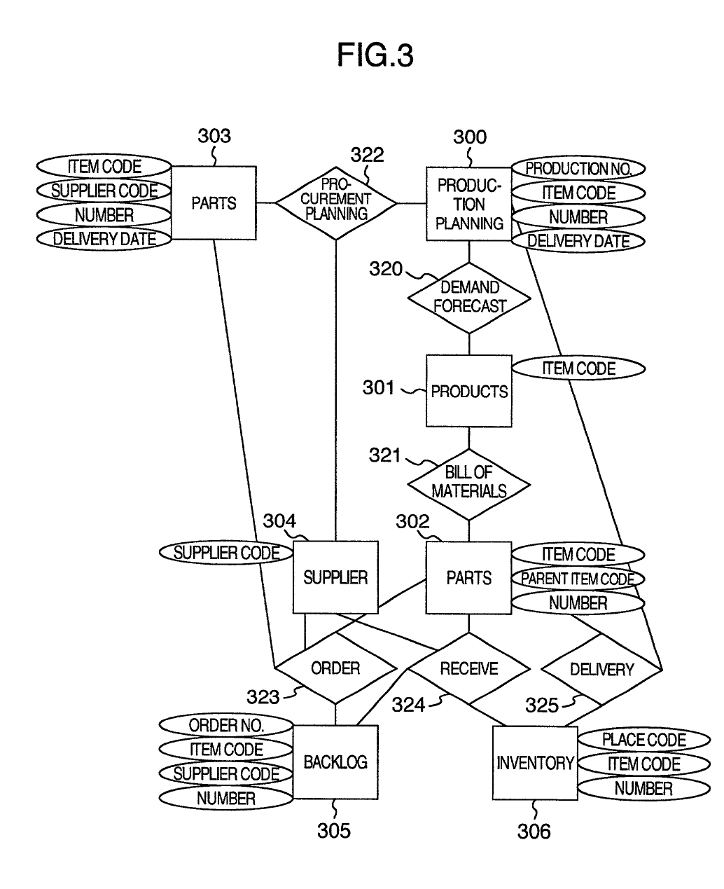

FIG. 3 shows the data model of templates. It includes the entity group of input/output information and related concept and forms necessary for the killer application to perform planning management. In other words, the data model entity is first constructed by production planning 300, backlog 305, inventory 306 and parts 303 as three input information and one output information of the killer application. In addition, products 301, parts 302 and supplier 304 are redundantly provided between those information to be defined as new entities. The operations 320 through 325 are connected between those entities. The main information items at these entities are indicated by ellipses.

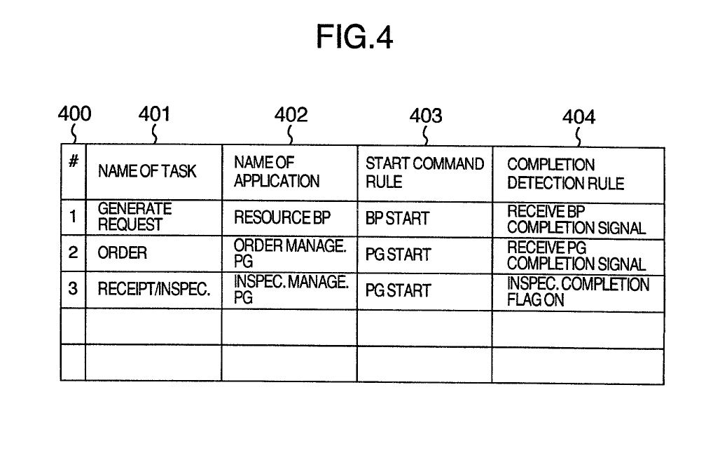

The cooperation function according to the invention will be described. FIG. 4 is a table showing the initiation/completion rule used in the initiation command function and completion detector function of the cooperation functions. On this table, column 401 lists the names of tasks that constitute each business process shown in FIG. 2. Column 402 indicates the names of applications that are executed at each task. Column 403 shows the rule for starting the corresponding application, and column 404 the rule for detecting the completion of the corresponding application.

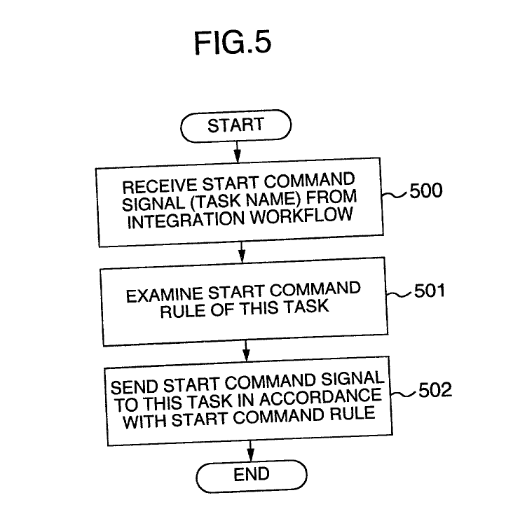

FIG. 5 shows the procedure that the initiation function takes as follows.

At step 500, a start command signal START (task name) is received from the integration workflow function. This signal is transmitted from the integration workflow function to the start command function when a new task step comes in the business process definition.

At step 501, the start command rule of the corresponding task is examined in the initiation/completion rule shown in FIG. 4.

At step 502, the start command signal is sent to the corresponding task in accordance with the corresponding start command rule.

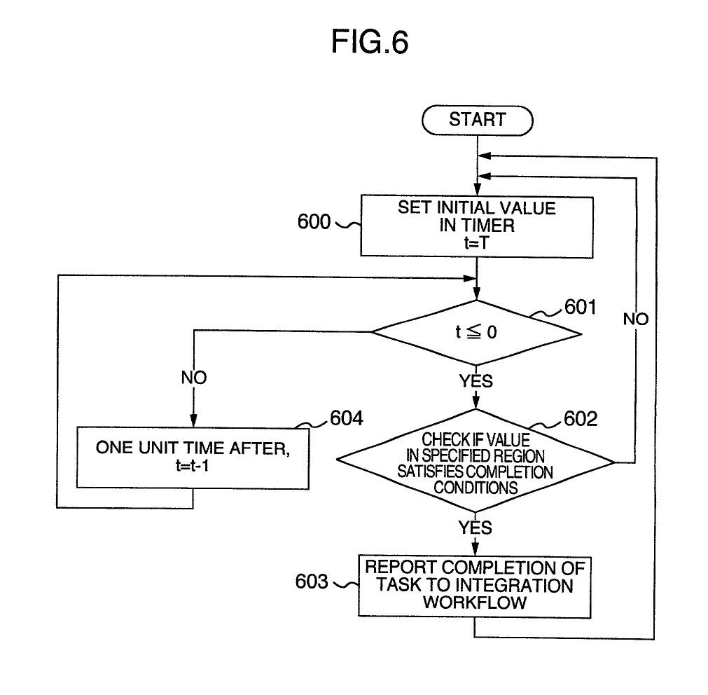

FIG. 6 is a flowchart for the completion detector, particularly the monitoring of change of values in the storage means such as database and files. The operations are as follows.

At step 600, cycle time T for monitoring is set as an initial value on a timer having this function just when the completion of an application has been started to detect by this function (t=T).

At step 601, it is checked if timer value t is less than 0 (t≦0). If it is smaller than or equal to 0, the process goes to step 602. If not so, the process goes to step 604.

At step 602, it is checked if the value in a specified region satisfies the completion conditions. If it satisfies, the process goes to step 603. If not so, the process goes back to step 600.

At step 603, the completion of the corresponding task is reported to the integration workflow function, and the process goes back to step 600.

At step 604, one unit time after, the timer value t is made to decrement by one (t=t−1), and the process goes back to step 601.

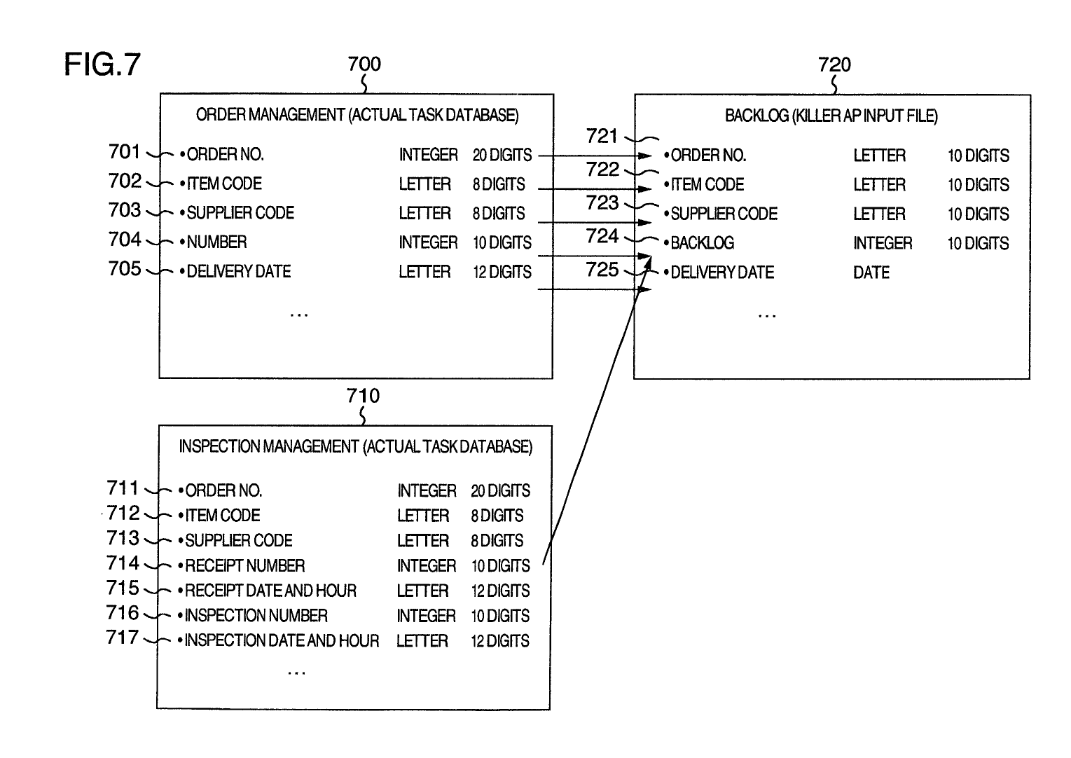

FIG. 7 shows the conversion rules used in the data transformer function and plan information identification function of the infrastructure. In this embodiment, purchase order management database 700 and inspection management database 710 in the actual business are converted to the order management database 720 in the high-speed material resource planning program. All information items 721 through 725, except 724, of order management database 720 respectively correspond to the information items of the purchase order management database 700, one to one. Therefore, only the data type and digit number of these information items are converted. The order management item 724 is estimated by subtracting receipt item 714 of inspection management 710 from the required-number item 704 of purchase order management 700.

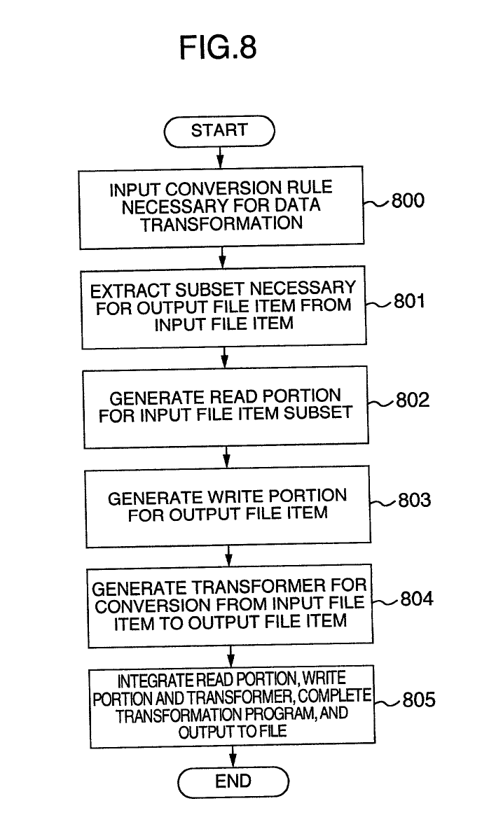

FIG. 8 is a flowchart of the program for the data transformer function. The flowchart is as follows.

At step 800, the conversion rules shown in FIG. 7 are inputted which are necessary for the data transformation.

At step 801, necessary sub-sets for the generation of the information items of output files are extracted from the information items of input files. In FIG. 7, they are the five items from 701 through 705 of purchase order management database 700, and the item 714 of examination management database 710.

At step 802, an information reading-in portion for input file items is generated by use of commands and application interface program for database access.

At step 803, an information writing portion for output file items is generated by use of the application interface program of high-speed material resource planning program.

At step 804, an information converter for the conversion from the input file items to the output file items is generated on the basis of the conversion rules inputted at step 800.

At step 805, the above reading-in portion, writing portion and converter are integrated, the data transformer is completed, and the transformer is outputted to the file.

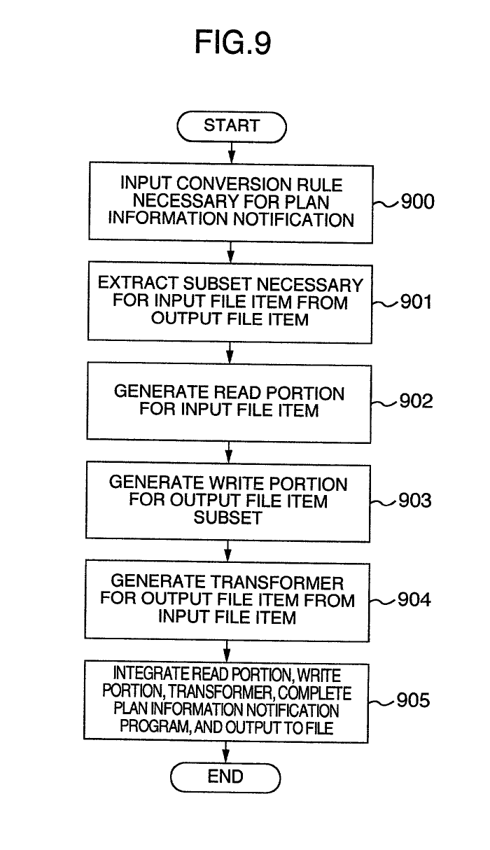

FIG. 9 is a flowchart of the program for the plan information notification function. The flowchart will be mentioned below.

At step 900, the conversion rules shown in FIG. 7 are inputted which are necessary for the plan information notification.

At step 901, sub-sets necessary for the generation of the input file items are extracted from the output file items.

At step 902, an information reading-in portion for the input file items is generated by use of the application interface program of high-speed material resource planning program.

At step 903, an information writing portion for the output file items is generated by use of the commands and application interface program for database access.

At step 904, an information converter for the conversion from the input file items to output file items is generated on the basis of the conversion rules inputted at step 900.

At step 905, the reading-in portion, writing portion and information converter are integrated, the plan information notification program is completed, and the program is outputted to the file.

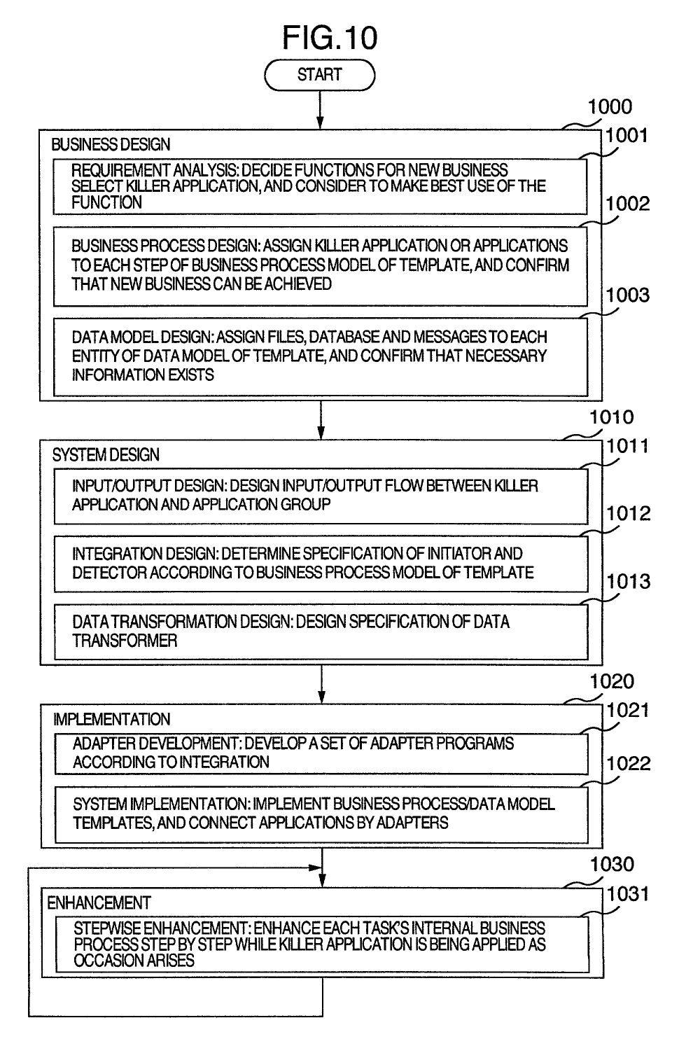

Finally, as shown in FIG. 10, the killer application is forced to cooperate with the existing/new applications by use of the applications-cooperation infrastructure that is constructed by the templates and cooperation functions mentioned above. This procedure is generally formed by four elements, or task design 1000, system design 1010, implementation 1020 and enhancement 1030.

### (1) Business Design Phase

At step 1001 (condition analysis), functions are determined for materializing new tasks. In this case, it is considered that the function of the killer application is used as best effectively as possible with reference to the business process model and data model in the templates of the killer application that is being applied.

At step 1002 (business process design), the killer application or applications for actual tasks are assigned to each step of the business process model shown in FIG. 2 of the templates, and it is confirmed that new tasks can be materialized.

At step 1003 (data model design), information storage means such as files, database and messages in the actual tasks are assigned to each entity of the data model shown in FIG. 3, in the templates, and it is confirmed that necessary information exists.

### (2) System Design Phase

At step 1011 (input/output design), an input/output flow is designed that lies between the killer application and the applications for the actual tasks.

At step 1012 (cooperation system design), the specification of the cooperation function for the start command and completion detection of applications is designed, in a form shown in FIG. 4, according to the business process model of templates.

At step 1013 (data conversion system design), the specification of the conversion between the input/output files of killer application (described as data model of templates) and information storage means for the actual tasks is designed in a form shown in FIG. 7.

### (3) Implementation Phase

At step 1021 (adapter development), the programs of start command, completion detection, data transformation and plan information notification according to the specification of the cooperation function are developed by the steps shown in FIGS. 5, 6, 8 and 9.

At step 1022 (system implementation), the business process model of templates is implemented by a workflow tool, and the data model is implemented by a database tool. In addition, the killer application and applications for the actual tasks are forced to cooperate with each other by use of cooperation parts.

### (4) Enhancement Phase

At step 1031 (stepwise enhancement), the actual tasks connected to each task step of the business process model are enhanced step by step while the killer application is being applied. This enhancement is made according to the use of application packages, development of new user programs and introduction of workflow.

According to the cooperation method and infrastructure for the integration of applications, of the invention, the macro procedures between the tasks to be combined can be developed in accordance with the business model and data model provided as templates. Moreover, the current business process and existing applications are incorporated as they are to form micro procedures for each task by use of the functions of integration workflow, start command, completion detection, information transformer and plan information notification provided as task cooperation functions. Therefore, the system development at the time of using the killer application can be achieved with less number of processes and in a short time.

Thus, the following effects can be expected.

Customer effect: a system for materializing a new business can be constructed with short delivery date, less number of processes, and high reliability. Then, the system can be enhanced step by step while the killer application is being applied.

System integration vendor effect: according to the infrastructure and method of the invention, anybody who is even not familiar with the business at which the killer application aims can break into the system integration business.

Software vendor: anybody can join in the businesses of software parts and design-support tools by standardizing the specification of task cooperation program.

What is claimed is:

1. A system for cooperating multiple applications, comprising:
templates that define procedures for executing a plurality of applications to be integrated; and
integration workflow means for executing said applications to be integrated according to said procedures defined by said templates.

2. A system according to claim 1, further comprising:
start command means for sending an execution start signal, to each application to be executed, on the basis of a command from said integration workflow means.

3. A system according to claim 1, further comprising:
completion detection means for informing said integration workflow means of having detected a signal indicating that a certain application has completed the execution.

4. A system according to claim 1, further comprising:
data transformer means for delivering the result of having executed a certain application to another application.

5. A method for cooperating multiple applications, comprising the steps of:
defining, on templates, procedures for executing a plurality of applications to be integrated; and
executing, said applications to be integrated, by integration workflow means according to said procedures defined on said templates.
